(19) United States
(12) Patent Application Publication
(10) Pub. No.: US 2025/0342045 A1
(43) Pub. Date: Nov. 6, 2025

(54) MACHINE LEARNING-BASED USER INTERFACE IN AN INFORMATION PROCESSING SYSTEM

(71) Applicant: Dell Products L.P., Round Rock, TX (US)

(72) Inventors: Mamatha Mahadevappa, Bangalore (IN); Debbie Nguyen, San Jose, CA (US); Shibi Panikkar, Bangalore (IN)

(21) Appl. No.: 18/652,431

(22) Filed: May 1, 2024

(51) Int. Cl. G06F 9/451

(52) U.S. Cl. CPC G06F 9/451

(57) ABSTRACT

Techniques for machine learning-based user interface functionalities in information processing systems are disclosed. For example, a method generates a data structure, as part of an interface between a user and an information processing system. The data structure comprises data representing one or more previous interactions between the user and the information processing system, wherein generating the data structure comprises utilizing one or more machine learning models. The method utilizes the data structure to respond to one or more subsequent interactions between the user and the information processing system.

### FIELD

The field relates generally to information processing systems, and more particularly to techniques for user interfaces in such information processing systems.

### BACKGROUND

Digital commerce systems, e.g., information processing systems configured to enable buyers (e.g., customers) and sellers (e.g., manufacturers/vendors or, more generally, enterprises) to conduct transactions over a computer network, have become the ubiquitous form of interaction between such entities. Furthermore, in the manufacturing industry, for example, such digital commerce systems also typically include web applications that are made available by original equipment manufacturers (OEMs) to customers. Existing web applications have a traditional user interface due to the traditional nature of the supply chain process and the amount of data that the customer (user) may need to be shown. As such, existing user interfaces for web applications are constrained.

Such user interface constraints cause technical issues with respect to resources of the underlying distributed computer network on which the digital commerce system resides and executes. For example, computer processing delays, data storage shortages, and/or communication network congestion occurs, especially when automated resolutions of such constraints cause additional resources in the digital commerce system to be needed.

### SUMMARY

Illustrative embodiments provide techniques for machine learning-based user interface functionalities in information processing systems. While techniques illustratively described herein are particularly well-suited for digital commerce systems, the user interface techniques are more broadly applicable to a wide variety of other information processing systems.

For example, in one or more illustrative embodiments, a method generates a data structure, as part of an interface between a user and an information processing system. The data structure comprises data representing one or more previous interactions between the user and the information processing system, wherein generating the data structure comprises utilizing one or more machine learning models. The method utilizes the data structure to respond to one or more subsequent interactions between the user and the information processing system.

These and other illustrative embodiments include, without limitation, methods, apparatus, networks, systems and processor-readable storage media.

### BRIEF DESCRIPTION OF THE DRAWINGS

FIG. 1 illustrates an information processing system in which machine learning-based user interface functionalities according to one or more illustrative embodiments can be implemented.

FIG. 2 illustrates a machine learning-based user interface system architecture according to an illustrative embodiment.

FIG. 3 illustrates further details of a machine learning-based user interface system architecture according to an illustrative embodiment.

FIG. 4 illustrates a process associated with a machine learning-based user interface system architecture according to an illustrative embodiment.

FIG. 5 illustrates a machine learning-based user interface methodology according to an illustrative embodiment.

FIGS. 6 and 7 illustrate examples of processing platforms that may be utilized to implement at least a portion of an information processing system in illustrative embodiments.

### DETAILED DESCRIPTION

Illustrative embodiments will be described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as used herein is intended to be broadly construed, so as to encompass, processing systems comprising compute, storage and/or network resources, other types of processing systems comprising various combinations of physical and/or virtual resources, as well as other types of distributed computer networks.

As mentioned, existing user interfaces in web applications are constrained. For example, it is realized herein that some reasons for such constraints include: (i) limited displayable area on web pages; (ii) limited HyperText Markup Language (HTML) controls; (iii) lack of knowledge or limited knowledge of customer requirements or preferences; (iv) need for customer to infer knowledge based on limited details given in the web applications; (v) excessive steps (e.g., clicks) to complete a customer action; and (vi) lack of a standard way to proactively inform customers about critical events and processes.

Among other technical issues, such user interface constraints can lead to a significant increase in communications over the digital commerce system between the OEM and the customer in terms of explanation and resolution resulting in technical issues with respect to resources of the underlying distributed computer network on which the digital commerce system resides and executes. For example, computer processing delays, data storage shortages, and/or communication network congestion occurs, especially when automated resolutions of such constraints cause additional resources in the digital commerce system to be needed.

Illustrative embodiments overcome the above and other technical deficiencies of web applications and, in general, user interfaces, by providing machine learning (ML) based user interface functionalities that, inter alia, anticipate needs, understand and respond to customer intent, and focus on driving customer benefits. In some embodiments, ML-based user interface functionalities, illustratively referred to herein as core system functionalities can be implemented as one or more independent components that can be overlaid on a traditional user interface.

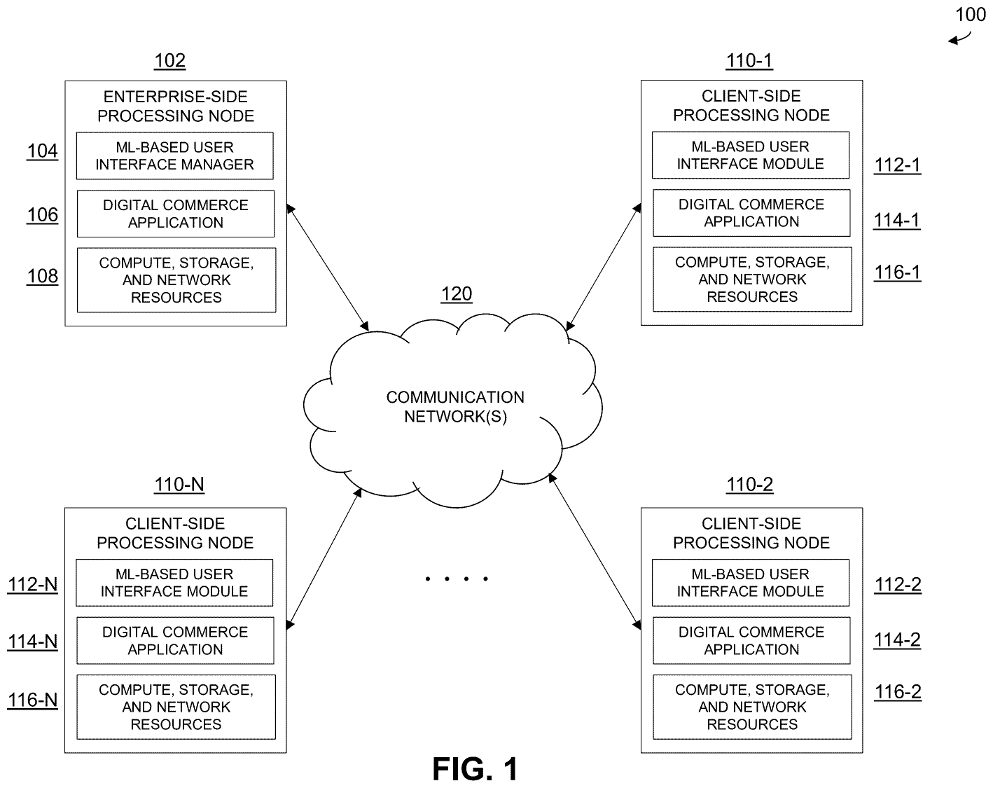

FIG. 1 illustrates an information processing system 100 in which machine learning-based user interface functionalities according to one or more illustrative embodiments can be implemented. As shown, information processing system 100 includes an enterprise-side processing node 102 and client-side processing nodes 110-1, 110-2, . . . , 102-N (may hereinafter each individually be referred to as client-side processing nodes 110 or collectively as client-side processing nodes 110). Enterprise-side processing node 102 and client-side processing nodes 110 are operatively coupled to one another via one or more communication networks 120.

As further shown, enterprise-side processing node 102 comprises an ML-based user interface manager 104, a digital commerce application 106, and a set of compute, storage, and network resources 108. Client-side processing node 110-1 comprises an ML-based user interface module 112-1, a digital commerce application 114-1, and a set of compute, storage, and network resources 116-1. Client-side processing node 110-2 comprises an ML-based user interface module 112-2, a digital commerce application 114-2, and a set of compute, storage, and network resources 116-2. Client-side processing node 110-N comprises an ML-based user interface module 112-N, a digital commerce application 114-N, and a set of compute, storage, and network resources 116-N. ML-based user interface modules 112-1, 112-2, . . . , 112-N may hereinafter each individually be referred to as ML-based user interface module 112 or collectively as ML-based user interface modules 112. Digital commerce applications 114-1, 114-2, . . . , 114-N may hereinafter each individually be referred to as digital commerce application 114 or collectively as digital commerce applications 114. Sets of compute, storage, and network resources 116-1, 116-2, . . . , 116-N may hereinafter each individually be referred to as set of compute, storage, and network resources 116 or collectively as sets of compute, storage, and network resources 116.

In some embodiments, information processing system 100 may be considered a digital commerce system. By way of example only, in the above-mentioned OEM/customer scenario, assume enterprise-side processing node 102 is associated with the OEM and client-side processing nodes 110 are respectively associated with customers. While digital commerce application 114 running on each client-side processing node 110 provides general digital commerce functions (e.g., product/service offerings, product/service selection, etc.) that are managed by digital commerce application 106 in enterprise-side processing node 102, assume that ML-based user interface module 112 in each client-side processing node 110 provides client-side ML-based user interface functions managed by ML-based user interface manager 104 in enterprise-side processing node 102. Further, the set of compute, storage, and network resources 108 in enterprise-side processing node 102 and the sets of compute, storage, and network resources 116 respectively in client-side processing nodes 110 may then collectively comprise what is mentioned herein as the resources of the underlying computer system upon which the digital commerce system resides and executes.

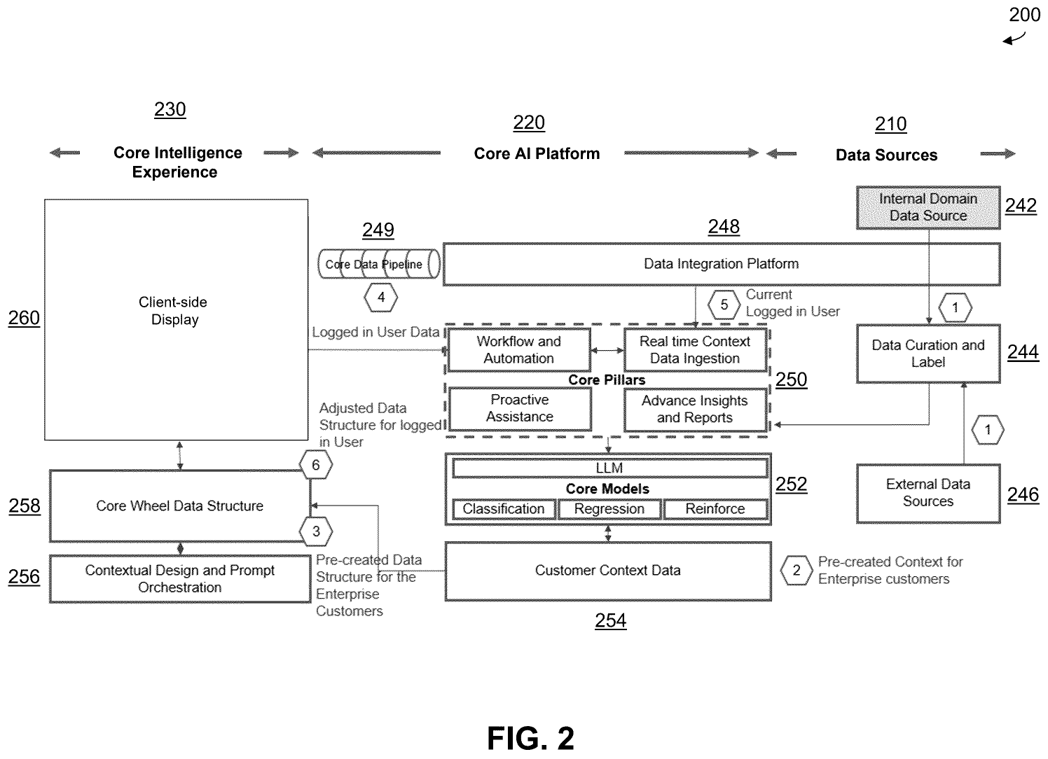

Referring now to FIG. 2, a machine learning-based user interface system architecture 200 according to an illustrative embodiment is depicted. Machine learning-based user interface system architecture 200 may also be illustratively referred to herein and in the figures as a core system architecture. By way of example only, in some embodiments, machine learning-based user interface system architecture 200 (hereinafter, simply, system architecture 200) can be implemented across enterprise-side processing node 102 and one or more of client-side processing nodes 110 of FIG. 1. More particularly, in some embodiments, ML-based user interface manager 104 in enterprise-side processing node 102 is configured to implement the modules and the functionalities of system architecture 200 with a client-side display being implemented by ML-based user interface module 112 in each client-side processing node 110. The client-side display enables each customer to submit queries and/or data to system architecture 200 which, in turn, provides responses and/or takes other actions using the core system functionalities, as will be further described herein.

More particularly as shown, system architecture 200 collectively comprises a data source portion 210, a core artificial intelligence (AI) platform portion 220, and a core intelligence experience portion 230. As illustratively used herein, the term AI is intended to be synonymous with the term ML in terms of functionalities that are configured in system architecture 200. Also, the term ML, as illustratively used herein, is intended to include generative AI techniques including, but not limited to, large language model (LLM) based techniques. Further, ML classification, ML regression, and ML reinforcement models may be utilized in some embodiments.

As further shown in FIG. 2, system architecture 200 includes an internal domain data source 242, a data curation and label module 244, and external data sources 246. Further, system architecture 200 includes a data integration platform 248, a core data pipeline 249, core pillars 250 (including modules for, e.g., workflow and automation, real time context data ingestion, proactive assistance, and advance insights and reports), core models 252 (including, e.g., LLM, classification, regression, and reinforcement models), customer context data 254, contextual design and prompt orchestration 256, core wheel data structure 258, and a client-side display 260. Note that data from internal domain data source 242 can include internal data collected by the enterprise (e.g., data descriptive of previous digital commerce transactions of each customer, as well as other forms of internal data), while data from external data sources 246 can include data collected from external sources with data relevant to the customers (e.g., public reviews on social media or other sites attributable to the customers regarding previous digital commerce transactions, as well as other forms of external data).

In some illustrative embodiments, the concept of a core wheel data structure (e.g., 258) represents the customer experience with the OEM (enterprise). The term “wheel” is a non-limiting term simply used to illustrate the notion that a customer's experience with an enterprise across a digital commerce system, and otherwise, is multifaceted with many distinct aspects (segments) similar to a wheel (or circle) that is divided into multiple sectors. For example, each segment in the core wheel data structure 258 represents a distinct part of an experience (e.g., ordering, billing, subscriptions, etc.) and can be considered a data representation for each specific customer that is initially created, and then modified as subsequent interactions occur, based on customer context data. In some illustrative embodiments, the core wheel data structure 258 is built based on AI driven data processing, as will be further described below.

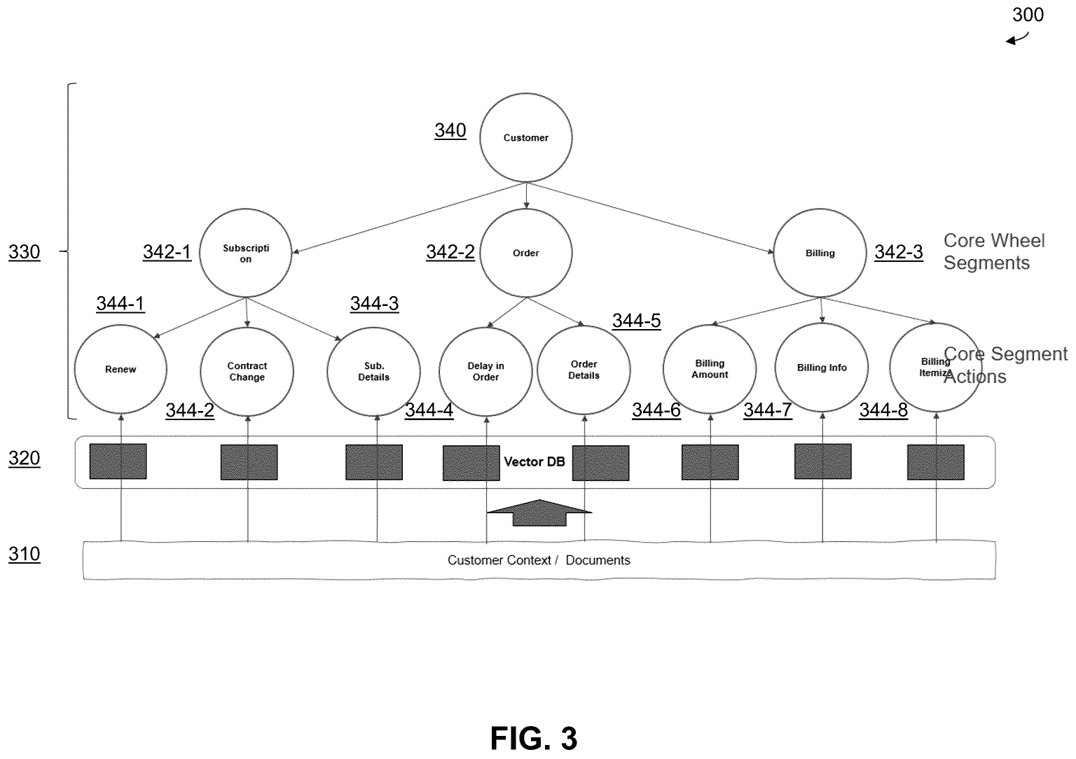

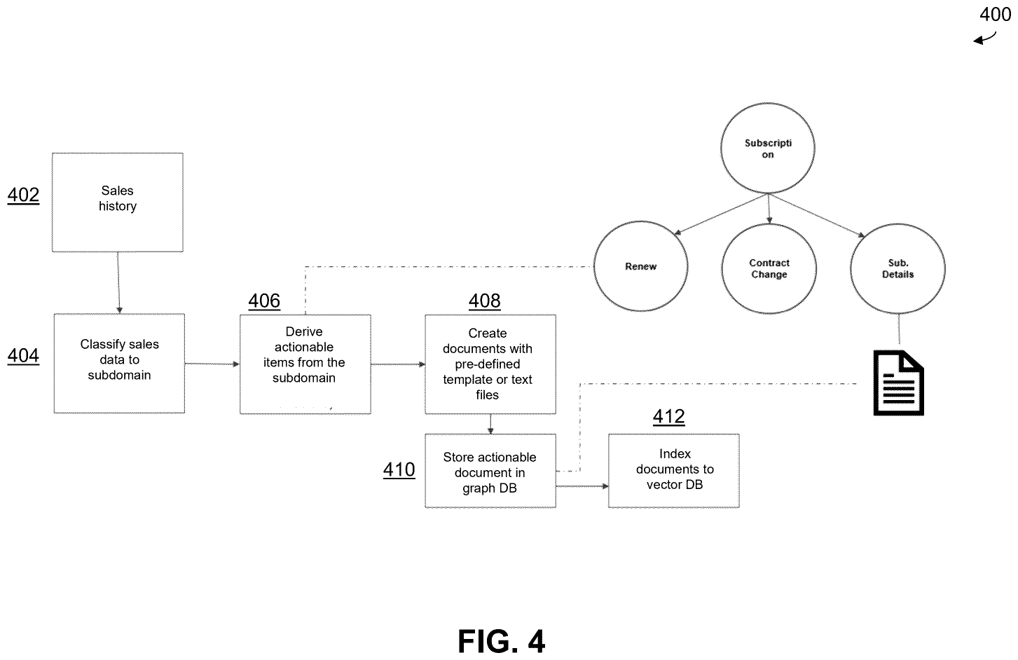

A high level process flow associated with system architecture 200 will now be described with reference to stages denoted as hexagonally outlined numbers 1-6 in FIG. 2. For example, as referenced in stage 1, data curation and label module 244 obtains data from internal domain data source 242 and/or external data sources 246. Data curation illustratively refers to the pre-processing (e.g., organization, integration, etc.) of data collected from multiple sources. Pre-processing the data may also include annotating or labeling the data so that the data is normalized and easily accessible by other components of system architecture 200. In stage 2, modules of core pillars 250 are configured as a data preparation and management layer that use one or more core models 252 to pre-create a context, stored in customer context data 254, for each customer based on the curated data from data curation and label module 244. Stage 3 then pre-creates a core wheel data structure 258 for each customer which is then accessible for query and/or adjustment via contextual design and prompt orchestration 256. Given the pre-created core wheel data structure 258, stage 4 corresponds to a given customer logging in whereby core data pipeline 249 activates to receive real time data that is presented to data integration platform 248 that will be used to adjust, as appropriate, the pre-created core wheel data structure 258 for that given customer in stage 5. Data integration platform 248 is a component that integrates real time data ingested in the system architecture 200, specific to the given customer, from different transactional components, data lakes, data marts, or the like, of the digital commerce system. Stage 6 thus represents the availability of the adjusted core wheel data structure 258. Further description of core wheel processing in system architecture 200 will be provided below in the context of illustrative embodiments depicted in FIGS. 3 and 4.

FIG. 3 illustrates further details of system architecture 200 according to an illustrative embodiment. More particularly, FIG. 3 shows an example 300 illustrating a process of creating a core wheel data structure 258 from customer context data 254.

As shown, customer context/documents 310 (e.g., part of customer context data 254) are stored in or otherwise accessible to a vector database 320. Vector database 320 can be part of customer context data 254 in some embodiments or contextual design or prompt orchestration module 256 in other embodiments. A core wheel data structure 330 comprising a set of interconnected nodes (each comprising data, as illustratively described below) is generated from vector database 320. A vector database is data stored as mathematical representations to facilitate machine learning models to access previous data inputs in order to enable performance of searches, recommendations, and text generation functionalities. Core wheel data structure 330 can be considered a hierarchical information graph, generated from vector database 320 and stored in a graph database (not expressly shown), that details the given customer experience across various segments of interactions with the enterprise.

For example, as further shown in FIG. 3, for a given customer, e.g., customer node 340, core wheel data structure 330 includes a plurality of core wheel segment nodes including a subscription segment node 342-1 (e.g., corresponding to data indicative of an experience for the customer regarding a subscription with the enterprise, e.g., an Infrastructure-as-a-Service (IaaS) subscription offered by the enterprise), an order segment node 342-2 (e.g., corresponding to data indicative of an experience for the customer regarding an order placed with the enterprise, e.g., a purchase or lease of a storage array manufactured by the enterprise), and a billing segment node 342-3 (e.g., corresponding to data indicative of an experience for the customer regarding the billing for a subscription or an order placed with the enterprise, e.g., payment terms, payment issues, etc.).

Each core wheel segment node also has a set of action nodes associated therewith. For example, a renew action node 344-1, a contract change action node 344-2, and a sub-details action node 344-3 are connected to subscription segment node 342-1. Further, a delay in order action node 344-4 and an order details action node 344-5 are connected to order segment node 342-2. Still further, a billing amount action node 344-6, a billing information action node 344-7, and a billing itemize action node 344-8 are connected to billing segment node 342-3. Each action node 344-1 through 344-8 includes detailed data and actionable rules respectively corresponding to the segment node (342-1, 342-2, and 342-3) to which it is connected. For example, in some embodiments, for each subdomain (segment node) and action leaf (action node), customer data is converted to accessible documents associated therewith so as to facilitate response by system architecture 200 to an actionable prompt from the customer.

Note that while FIG. 3 illustrates one level of action nodes 344-1 through 344-8 (considered leaf nodes of respective segment nodes 342-1, 342-2, and 342-3), in some embodiments, one or more additional levels of action nodes (leaf nodes representing sub-actions of actions) that hierarchically connect with the level of action nodes 344-1 through 344-8 may be created as part of core wheel data structure 330.

Accordingly, as illustrated in the FIG. 3 example, core wheel data structure 330 is a hierarchical graph which maps the experience of a customer (customer node 340) to a subdomain (segment nodes 342-1, 342-2, or 342-3) and to different subdomain actions (action nodes 344-1 through 344-8). Each experience is also mapped to the customer context/documents 310 (e.g., action documents) that are indexed in vector database 320. Many action documents create the segment documents, and many segment documents creates the customer context documents. Core wheel data structure 330 is searchable based on prompts, e.g., prompts that a customer submitted (e.g., query) or system generated prompts based on customer activity.

By way of an example of a use case for core wheel data structure 330, assume for a specific customer, segment nodes (e.g., segment nodes 342-1, 342-2, or 342-3) are derived based on transactional data, e.g., data indicative of transactions between the customer and enterprise on the digital commerce system. For example, internal domain data source 242 and/or external data sources 246 in FIG. 2 can be part of a digital commerce system which stores such transactional data. Then, for each segment node, actions nodes (e.g., action nodes 344-1 through 344-8) are derived as needed/desired in accordance with customer interactions with system architecture 200. Each of the action nodes are mapped to different context documents (action or activity documents) created by the data management process (e.g., core pillars 250 and core models 252) as leaf nodes. Each context document is indexed in vector database 320. Each leaf node of actions is mapped to vector database 320 with a similarity search based on a prompt interaction. Each of the action nodes are associated with certain rules, e.g., renew is the action and the rule is “notify customer 15 days (about 2 weeks) before the renewal date.” When satisfying the rules, system architecture 200 generates the prompt to obtain the details of the subscription that needs renewal. In some embodiments, such details can be searched against the embedded activity documents by an LLM in core models 252 and returned in response to the system generated prompt. In some embodiments, the renewal reminder is proactively shown to the customer when they log in.

Note that, in some embodiments, a random forest regression model (e.g., part of core models 252) is used to classify segments (subdomains) that are then represented as segment nodes 342-1, 342-2, or 342-3 in core wheel data structure 330. For example, for order segment node 342-2, random forest regression classification may be based on sales parameters, and if a new sale occurs, the new sale will be classified to the correct segment node. As customer interaction/experience progresses with respect to the enterprise and/or underlying digital commerce system, new subdomain classifications and thus, new segment nodes and new action nodes, can be created in core wheel data structure 330.

FIG. 4 illustrates a process 400 associated with a machine learning-based user interface system architecture according to an illustrative embodiment. For example, in some embodiments, process 400 can be executed by system architecture 200 to create a core wheel data structure 330 in FIG. 3. As shown, sales history data is obtained in step 402. The sales data is classified to a subdomain (e.g., segment node) in step 404. In step 406, one or more actionable items (e.g., action nodes) are derived from the subdomain. Step 408 creates an actionable document with a predefined template or simply as a text file, which is then stored in a graph database (e.g., database that stores the core wheel data structure) in step 410. Step 412 then indexes the actionable document in a vector database.

Advantageously, for each subdomain, and action leaf, the customer data is converted to documents, so as to facilitate quick responses to the actionable prompts from the customer. Rather than directly processing the prompt against the entire customer document (where the similarity search can be inaccurate), the prompt is narrowed down to an actionable leaf, and the index of that activity document is loaded for the LLM to search. This yields more accurate and faster response times for query actions. The core wheel data structure is updated (adjusted, modified, etc.) based on the current logged in user's activities that are tracked through the core data pipeline and data integration platform.

In one use case example, assume an information technology (IT) administrator for a customer entity in Country A with multiple offices across the country wants to change the address of the main office. The IT administrator starts a conversation with system architecture 200 and asks to update the office address. A proactive assistance module in core pillars 250 assists by bringing up the current address and asking for the new address. Once the new address is shared, system architecture 200 updates it in the customer profile. At this point, an advance insights and reports module in core pillars 250 checks that there is an order placed to be delivered to the current address and it is still in the procurement phase. System architecture 200 notifies the IT administrator the address for this order needs to be updated to the new address. The IT administrator confirms that this order should be delivered to the new address and system architecture 200 updates the order delivery address accordingly.

Further assume that while the order will be delivered to the new office address in the coming week, system architecture 200 proactively notices that one of the product licenses is not activated in this order and it is going to expire and miss the warranty period extension. System architecture 200 triggers notification to the customer entity, the IT administrator, and/or other stakeholder via email or push notification. When the IT administrator logs back in, system architecture 200 highlights this action for the IT administrator to review along with all the information collected and ready for the license activation to be completed.

System architecture 200 can also include the following functionalities. A mean time to resolution (MTTR) metric can be used when there is an issue in the customer's account or solution. In case of the account where the customer cannot access specific data, system architecture 200 can be used to provide access, or request access to be provided, such as group access or site settings. For enterprise customers, when data access is down, system architecture 200 can help troubleshoot and pinpoint where the problem is, hence reducing the time it takes to resolution. In each of these examples, system architecture 200 can use MTTR to measure how long it takes for customers to resolve their issue, based on guidance of system architecture 200 and the ML models behind it.

Since system architecture 200 is built on ML models that continue to learn based on customer responses and actions, system architecture 200 can measure how accurate these responses are based on the follow up questions provided by the customer, customers providing thumbs up or down based on the responses, and ultimately, whether the responses enable the customer to complete their task.

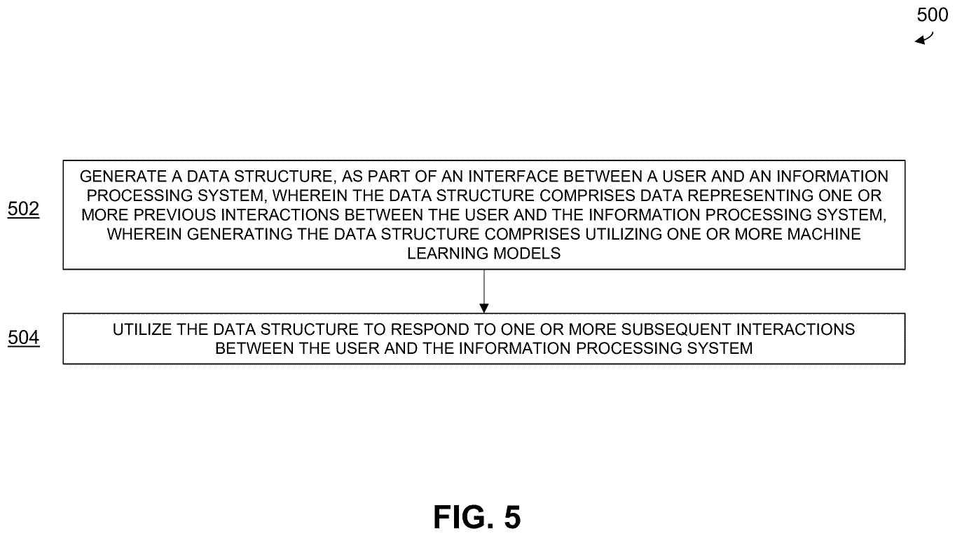

FIG. 5 illustrates a machine learning-based user interface methodology 500 according to an illustrative embodiment. As shown, step 502 generates a data structure, as part of an interface between a user and an information processing system. The data structure comprises data representing one or more previous interactions between the user and the information processing system, wherein generating the data structure comprises utilizing one or more machine learning models. Step 504 utilizes the data structure to respond to one or more subsequent interactions between the user and the information processing system.

In some embodiments, the method may further comprise updating the data structure based the one or more subsequent interactions between the user and the information processing system.

In some embodiments, generating the data structure may further comprise classifying at least a portion of the data representing the one or more previous interactions between the user and the information processing system into one or more domains using at least one of the one or more machine learning models.

In some embodiments, generating the data structure may further comprise deriving one or more actions from at least a portion of the data representing the one or more previous interactions between the user and the information processing system, and associating the one or more derived actions with the one or more domains to which the one or more derived actions correspond. The one or more derived actions may be associated with one or more rules.

In some embodiments, the data structure may comprise a hierarchical data structure comprising one or more first nodes representing the one or more domains and one or more second nodes representing the one or more actions, and the one or more second nodes are connected to the one or more first nodes to which they correspond. Further, the one or more second nodes may be mapped to one or more user-specific context documents, and the one or more user-specific context documents may be indexed in a vector database operatively coupled between the one or more user-specific context documents and the hierarchical data structure.

In some embodiments, utilizing the data structure to respond to the one or more subsequent interactions between the user and the information processing system may further comprise: searching the one or more user-specific context documents utilizing at least another one of the one or more machine learning models; generating one or more responses to the one or more subsequent interactions; and causing presentation of the one or more responses on the interface to the user. At least one of the one or more responses may be generated for proactive presentation to the user on the interface prior to at least one of the one or more subsequent interactions.

In some embodiments, the information processing system may comprise a digital commerce system.

In some embodiments, the interface may be overlayed on a web application associated with the digital commerce system.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

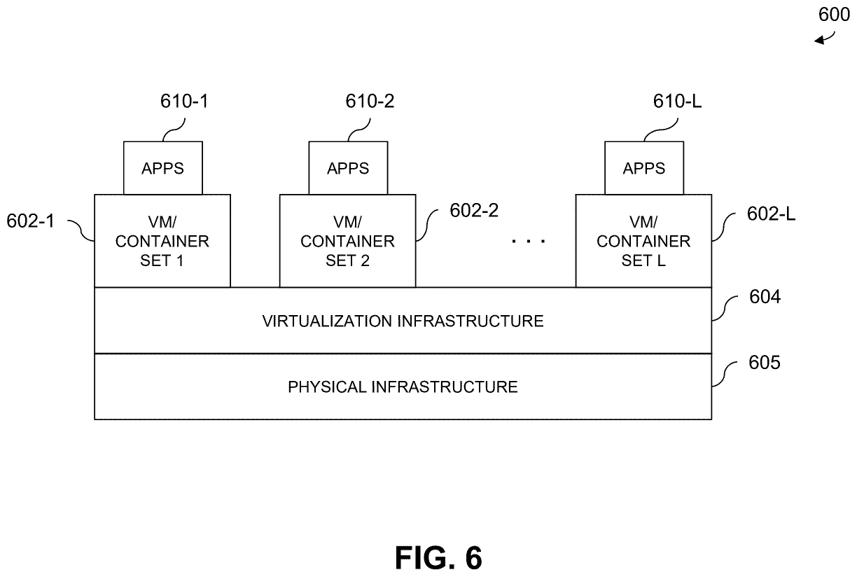

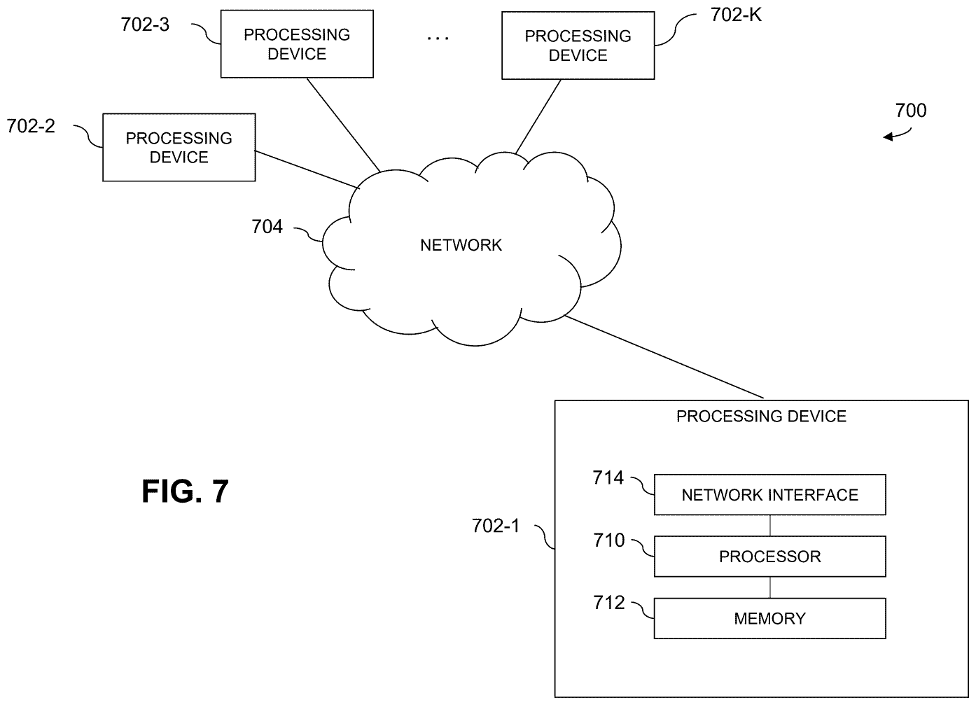

Illustrative embodiments of processing platforms utilized to implement functionality for machine learning-based user interface functionalities will now be described in greater detail with reference to FIGS. 6 and 7. Although described in the context of the information processing system environment mentioned herein, these platforms may also be used to implement at least portions of other information processing systems in other embodiments.

FIG. 6 shows an example processing platform comprising infrastructure 600. Infrastructure 600 comprises a combination of physical and virtual processing resources that may be utilized to implement at least a portion of the information processing system 100 in FIG. 1. Infrastructure 600 comprises multiple virtual machines (VMs) and/or container sets 602-1, 602-2, . . . 602-L implemented using virtualization infrastructure 604. The virtualization infrastructure 604 runs on physical infrastructure 605, and illustratively comprises one or more hypervisors and/or operating system level virtualization infrastructure. The operating system level virtualization infrastructure illustratively comprises kernel control groups of a Linux operating system or other type of operating system.

Infrastructure 600 further comprises sets of applications 610-1, 610-2, . . . 610-L running on respective ones of the VMs/container sets 602-1, 602-2, . . . 602-L under the control of the virtualization infrastructure 604. The VMs/container sets 602 may comprise respective VMs, respective sets of one or more containers, or respective sets of one or more containers running in VMs.

In some implementations of the FIG. 6 embodiment, the VMs/container sets 602 comprise respective VMs implemented using virtualization infrastructure 604 that comprises at least one hypervisor. A hypervisor platform may be used to implement a hypervisor within the virtualization infrastructure 604, where the hypervisor platform has an associated virtual infrastructure management system. The underlying physical machines may comprise one or more distributed processing platforms that include one or more storage systems.

In other implementations of the FIG. 6 embodiment, the VMs/container sets 602 comprise respective containers implemented using virtualization infrastructure 604 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of information processing system environments mentioned herein may each run on a computer, server, storage device or other processing platform element. A given such element may be viewed as an example of what is more generally referred to herein as a “processing device.” Infrastructure 600 shown in FIG. 6 may represent at least a portion of one processing platform. Another example of such a processing platform is processing platform 700 shown in FIG. 7.

The processing platform 700 in this embodiment comprises at least a portion of information processing systems 100, 200, and 300 and includes a plurality of processing devices, denoted 702-1, 702-2, 702-3, . . . 702-K, which communicate with one another over a network 704.

The network 704 may comprise any type of network, including by way of example a global computer network such as the Internet, a WAN, a LAN, a satellite network, a telephone or cable network, a cellular network, a wireless network such as a WiFi or WiMAX network, or various portions or combinations of these and other types of networks.

The processing device 702-1 in the processing platform 700 comprises a processor 710 coupled to a memory 712.

The processor 710 may comprise a microprocessor, a microcontroller, an application-specific integrated circuit (ASIC), a field-programmable gate array (FPGA), a central processing unit (CPU), a graphical processing unit (GPU), a tensor processing unit (TPU), a video processing unit (VPU) or other type of processing circuitry, as well as portions or combinations of such circuitry elements.

The memory 712 may comprise random access memory (RAM), read-only memory (ROM), flash memory or other types of memory, in any combination. The memory 712 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM, flash memory or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 702-1 is network interface circuitry 714, which is used to interface the processing device with the network 704 and other system components, and may comprise conventional transceivers.

The other processing devices 702 of the processing platform 700 are assumed to be configured in a manner similar to that shown for processing device 702-1 in the figure.

Again, the particular processing platform 700 shown in the figure is presented by way of example only, and information processing system environments mentioned herein may include additional or alternative processing platforms, as well as numerous distinct processing platforms in any combination, with each such platform comprising one or more computers, servers, storage devices or other processing devices. For example, other processing platforms used to implement illustrative embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

As indicated previously, components of an information processing system as disclosed herein can be implemented at least in part in the form of one or more software programs stored in memory and executed by a processor of a processing device. For example, at least portions of the functionality for application monitoring with predictive anomaly detection and fault isolation as disclosed herein are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems, edge computing environments, applications, etc. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. An apparatus comprising:
at least one processing platform comprising at least one processor coupled to at least one memory, the at least one processing platform, when executing program code, is configured to:
manage an interface between a user and an information processing system, wherein, when managing the interface, the at least one processing platform is further configured to:
generate a data structure comprising data representing one or more previous interactions between the user and the information processing system, wherein generation of the data structure comprises utilizing one or more machine learning models; and
utilize the data structure to respond to one or more subsequent interactions between the user and the information processing system.

2. The apparatus of claim 1 wherein, when managing the interface, the at least one processing platform is further configured to update the data structure based the one or more subsequent interactions between the user and the information processing system.

3. The apparatus of claim 1 wherein, when managing the interface to generate the data structure, the at least one processing platform is further configured to classify at least a portion of the data representing the one or more previous interactions between the user and the information processing system into one or more domains using at least one of the one or more machine learning models.

4. The apparatus of claim 3 wherein, when managing the interface to generate the data structure, the at least one processing platform is further configured to derive one or more actions from at least a portion of the data representing the one or more previous interactions between the user and the information processing system, and to associate the one or more derived actions with the one or more domains to which the one or more derived actions correspond.

5. The apparatus of claim 4 wherein the one or more derived actions are associated with one or more rules.

6. The apparatus of claim 4 wherein the data structure comprises a hierarchical data structure comprising one or more first nodes representing the one or more domains and one or more second nodes representing the one or more actions, wherein the one or more second nodes are connected to the one or more first nodes to which they correspond.

7. The apparatus of claim 6 wherein the one or more second nodes are mapped to one or more user-specific context documents.

8. The apparatus of claim 7 wherein the one or more user-specific context documents are indexed in a vector database operatively coupled between the one or more user-specific context documents and the hierarchical data structure.

9. The apparatus of claim 7 wherein, when managing the interface to utilize the data structure to respond to the one or more subsequent interactions between the user and the information processing system, the at least one processing platform is further configured to: search the one or more user-specific context documents utilizing at least another one of the one or more machine learning models, generate one or more responses to the one or more subsequent interactions, and cause presentation of the one or more responses on the interface to the user.

10. The apparatus of claim 9 wherein at least one of the one or more responses is generated for proactive presentation to the user on the interface prior to at least one of the one or more subsequent interactions.

11. The apparatus of claim 1 wherein the information processing system comprises a digital commerce system.

12. A method comprising:
generating a data structure, as part of an interface between a user and an information processing system, wherein the data structure comprises data representing one or more previous interactions between the user and the information processing system, wherein generating the data structure comprises utilizing one or more machine learning models; and
utilizing the data structure to respond to one or more subsequent interactions between the user and the information processing system.

13. The method of claim 12 further comprising updating the data structure based the one or more subsequent interactions between the user and the information processing system.

14. The method of claim 13 wherein generating the data structure further comprises classifying at least a portion of the data representing the one or more previous interactions between the user and the information processing system into one or more domains using at least one of the one or more machine learning models.

15. The method of claim 14 generating the data structure further comprises deriving one or more actions from at least a portion of the data representing the one or more previous interactions between the user and the information processing system, and associating the one or more derived actions with the one or more domains to which the one or more derived actions correspond.

16. The method of claim 15 wherein the one or more derived actions are associated with one or more rules.

17. The method of claim 15 wherein the data structure comprises a hierarchical data structure comprising one or more first nodes representing the one or more domains and one or more second nodes representing the one or more actions, wherein the one or more second nodes are connected to the one or more first nodes to which they correspond, further wherein the one or more second nodes are mapped to one or more user-specific context documents, and still further wherein the one or more user-specific context documents are indexed in a vector database operatively coupled between the one or more user-specific context documents and the hierarchical data structure.

18. The method of claim 17 wherein utilizing the data structure to respond to the one or more subsequent interactions between the user and the information processing system further comprises:
searching the one or more user-specific context documents utilizing at least another one of the one or more machine learning models;
generating one or more responses to the one or more subsequent interactions; and
causing presentation of the one or more responses on the interface to the user.

19. The method of claim 18 wherein at least one of the one or more responses is generated for proactive presentation to the user on the interface prior to at least one of the one or more subsequent interactions.

20. A computer program product comprising a non-transitory processor-readable storage medium having stored therein program code of one or more software programs, wherein the program code when executed by at least one processing platform causes the at least one processing platform to:
manage an interface between a user and an information processing system, wherein, when managing the interface, the at least one processing platform is further configured to:
generate a data structure comprising data representing one or more previous interactions between the user and the information processing system, wherein generation of the data structure comprises utilizing one or more machine learning models; and
utilize the data structure to respond to one or more subsequent interactions between the user and the information processing system.
